(19) United States
(12) Patent Application Publication
(10) Pub. No.: US 2013/0059081 A1
(43) Pub. Date: Mar. 7, 2013

(54) METHOD OF FABRICATING FLEXIBLE SUBSTRATE STRUCTURE

(71) Applicants: Yung-Hui Yeh, Hsinchu City (TW); Chun-Cheng Cheng, Hsinchu City (TW); Chyi-Ming Leu, Hsinchu County (TW); Yung-Lung Tseng, Hsinchu County (TW)

(72) Inventors: Yung-Hui Yeh, Hsinchu City (TW); Chun-Cheng Cheng, Hsinchu City (TW); Chyi-Ming Leu, Hsinchu County (TW); Yung-Lung Tseng, Hsinchu County (TW)

(73) Assignee: INDUSTRIAL TECHNOLOGY RESEARCH INSTITUTE, Hsinchu (TW)

(21) Appl. No.: 13/600,220

(22) Filed: Aug. 31, 2012

Related U.S. Application Data
(62) Division of application No. 13/306,949, filed on Nov. 29, 2011.

(30) Foreign Application Priority Data
Sep. 1, 2011 (TW) 100131528

(51) Int. Cl. B05D 5/00; B05D 3/12

(52) U.S. Cl. 427/258

(57) ABSTRACT

A method of fabricating a flexible substrate structure is provided. A flexible metal carrier including at least one first region and at least one second region is provided. A surface-modified layer is formed on the first region of the flexible metal carrier. A flexible plastic substrate is formed over the first region and the second region of the flexible metal carrier. The flexible plastic substrate over the first region contacts with the surface-modified layer. The flexible plastic substrate over the second region contacts with the flexible metal carrier.

### CROSS-REFERENCE TO RELATED APPLICATION

This application is a divisional of and claims the priority benefit of U.S. application Ser. No. 13/306,949 filed on Nov. 29, 2011, now pending. The prior application Ser. No. 13/306,949 claims the priority benefit of Taiwan application serial no. 100131528, filed on Sep. 01, 2011. The entirety of each of the above-mentioned patent applications is hereby incorporated by reference herein and made a part of this specification.

### BACKGROUND

1. Technical Field

The disclosure relates to a substrate structure and a method of fabricating the same.

2. Related Art

A roll-to-roll continuous process is superior in low cost of fab construction and large-area productions, is suitable for application in a thin film transistor (TFT) array process, and has competitive edge over a sheet-to-sheet process of silicon semiconductor used nowadays.

A substrate employed in a general roll-to-roll continuous process is a flexible plastic substrate, such as polyethylene terephthalate (PET) or polyethylene naphthalate (PEN), polyimide (PI), and the forms of the product are mainly single-layer patterning of an indium tin oxide (ITO) thin film or single-layer patterning of a multi-layer thin film. To fabricate and develop electronic components, a photolithography process of more than two layers may be employed. However, the flexible plastic substrate may be deformed due to membrane stress in the process and reel tension of the equipment, thereby causing an error in alignment precision of photolithography of layers above the second one, so that it may be difficult to fabricate the electronic components.

### SUMMARY

A method of fabricating a flexible substrate structure is provided, which may capable of reducing the alignment errors among layers formed in photolithography and accomplishing a patterning process of more than two layers (including two layers).

A method of fabricating a flexible substrate structure is provided. A flexible metal carrier including at least one first region and at least one second region is provided. A surface-modified layer is formed on the first region of the flexible metal carrier. A flexible plastic substrate is formed over the first region and at least one portion of the second region of the flexible metal carrier. The flexible plastic substrate over the first region contacts with the surface-modified layer. The flexible plastic substrate over the second region contacts with the flexible metal carrier.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view of a flexible substrate structure according to an embodiment of the disclosure.

FIG. 2 is a top view of a flexible substrate structure according to an embodiment of the disclosure.

FIG. 3 is a top view of another flexible substrate structure according to an embodiment of the disclosure.

FIG. 4 is a top view of a still another flexible substrate structure according to an embodiment of the disclosure.

FIGS. 5A to 5C illustrate a separation mechanism of electronic components using the aforementioned flexible substrate structure according to the disclosure.

### DETAILED DESCRIPTION OF DISCLOSED EMBODIMENTS

In on embodiment, a method of fabricating a flexible substrate structure is provided, a simple and rapid method may be used for fabrication, and in the removal of the flexible plastic substrate.

Several exemplary embodiments accompanied with drawings are described in detail below to further describe the disclosure in details.

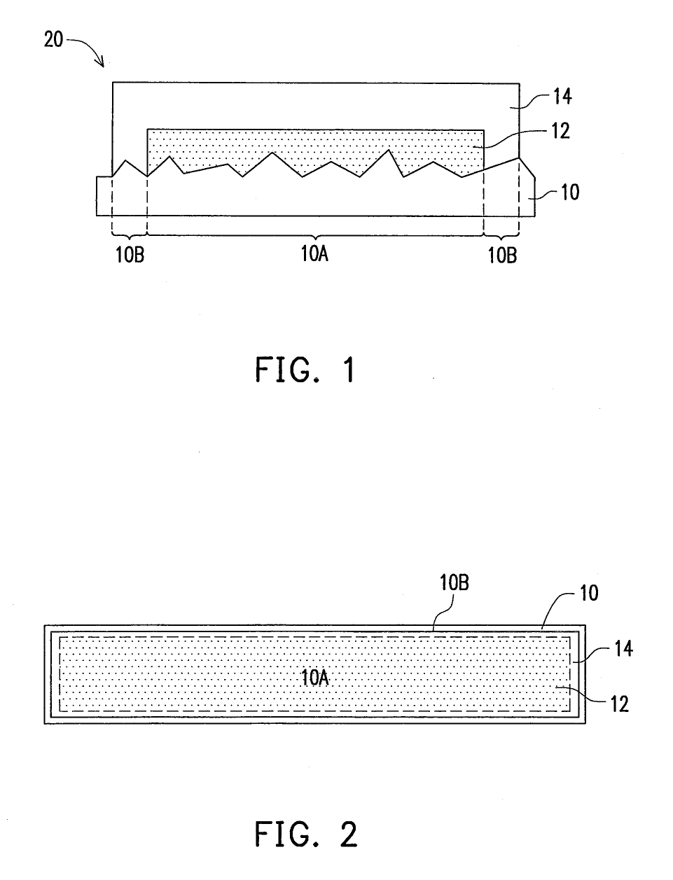

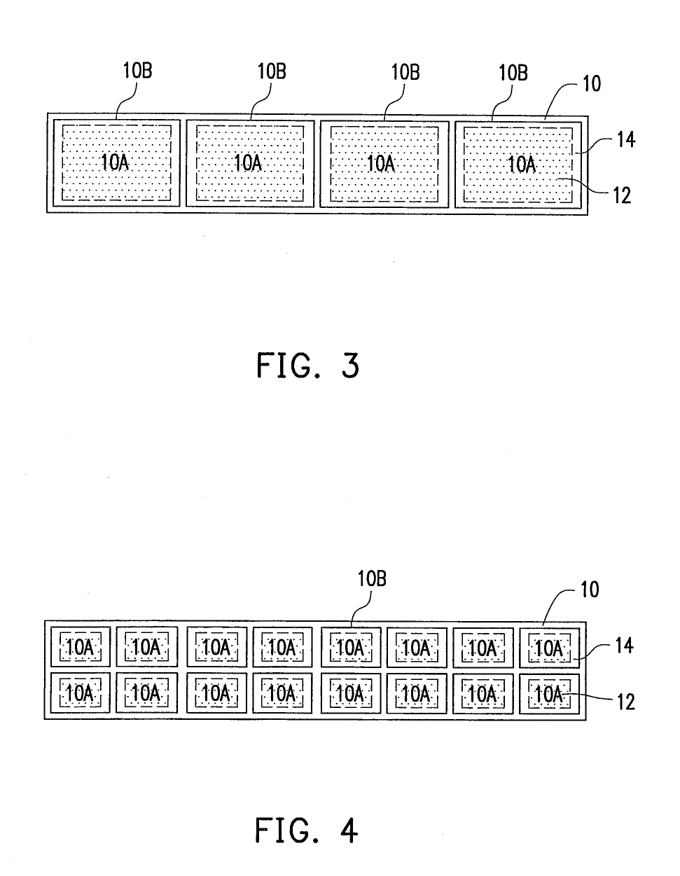

FIG. 1 is a schematic cross-sectional view of a flexible substrate structure according to an embodiment of the disclosure. FIG. 2 is a top view of a flexible substrate structure according to an embodiment of the disclosure. FIG. 3 is a top view of a flexible substrate structure according to another embodiment of the disclosure. FIG. 4 is a top view of a flexible substrate structure according to a still another embodiment of the disclosure.

Referring to FIG. 1, in one embodiment, a flexible substrate structure 20 includes a flexible metal carrier 10, a surface-modified layer 12 and a flexible plastic substrate 14.

The flexible metal carrier 10 includes a first region 10A and a second region 10B. The second region 10B may be located around the first region 10A, and the region over the first region 10A may be, for example, used for forming flexible electronic components, and the region over the second region 10B may be, for example, a peripheral region of the flexible electronic components. Referring to FIG. 2, in an embodiment, the flexible metal carrier 10 includes a single first region 10A and a single second region 10B, and the second region 10B surrounds the first region 10A. Referring to FIGS. 3 and 4, in other embodiments, the flexible metal carrier 10 includes a plurality of first regions 10A and a plurality of second regions 10B, and each second region 10B surrounds each first region 10A. The plurality of first regions 10A of the flexible metal carrier 10 in FIG. 3 is in a single column. The plurality of first regions 10A of the flexible metal carrier 10 in FIG. 4 is in a plurality of columns. In application, the first region 10A may be designed to have various sizes and configurations according to actual product requirements, and is not limited to those in the above. A material of the flexible metal carrier 10 may be, for example, a metal foil, and a thickness of the flexible metal carrier is about between 50 μm and 200 μm. A material of the metal foil includes stainless steel or metal alloy. The first region 10A and the second region 10B of the flexible metal carrier 10 both have a rough surface. The first region 10A of the flexible metal carrier 10 has a rough surface, which may increase an adhesion of the surface-modified layer 12 to the flexible metal carrier 10; and the second region 10B of the flexible metal carrier 10 has a rough surface, which may increase an adhesion of the flexible plastic substrate 14 to the flexible metal carrier 10. In an embodiment, a roughness of the flexible metal carrier 10 may be greater than 10 nm, for example, about 10 nm to 500 nm.

The surface-modified layer 12 is located on and may contact with the first region 10A of the flexible metal carrier 10. A process of forming the surface-modified layer 12 may be regarded as a process of planarizing the first region 10A of the flexible metal carrier 10. A roughness of the formed surface-modified layer 12 may be smaller than the roughness of the flexible metal carrier 10. In an embodiment, the roughness of the surface-modified layer 12 is smaller than 10 nm, for example, about 1 nm to 10 nm. The adhesion of the surface-modified layer 12 to the flexible metal carrier 10 may be greater than an adhesion of the flexible plastic substrate 14 to the surface-modified layer 12. The adhesion of the surface-modified layer 12 to the flexible metal carrier 10 may be, for example, 1 B to 5 B, in which B is an adhesion unit referring to ASTM (American Standard Test Method) D339. A material of the surface-modified layer 12 includes silicone epoxy, polyimide (pyromellitic dianhydride-diaminodiphenyl ether) (PI(PMDA-ODA)) or Teflon. A thickness of the surface-modified layer 12 is, for example, about 1 to 10 μm. The surface-modified layer 12 may be formed by various known coating methods, for example, dip coating, spin coating, roll coating or spray coating. The surface-modified layer 12 may be formed on the first region 10A shown in FIG. 2, FIG. 3 or FIG. 4. Since the material of the carrier 10 is metal, during the coating of the surface-modified layer 12, the surface-modified layer 12 may not be seriously deformed by the reel tension of the equipment and the resulting membrane stress, and thus the surface-modified layer 12 may be formed by a roll-to-roll method and has sufficient alignment precision in the subsequent photolithography process. However, the method of forming the surface-modified layer 12 is not limited to the roll-to-roll method, and may also be a sheet-to-sheet method or any other suitable method. In the embodiment shown in FIG. 2, the surface-modified layer 12 may be formed by a roll-to-roll continuous coating process. In the embodiments shown in FIGS. 3 and 4, the surface-modified layer 12 may be formed by a roll-to-roll discontinuous coating process.

The flexible plastic substrate 14 is located over the first region 10A and the second region 10B. The flexible plastic substrate 14 over the first region 10A contacts with the surface-modified layer 12, and the flexible plastic substrate 14 over the second region 10B contacts with the flexible metal carrier 10. The adhesion of the flexible plastic substrate 14 to the surface-modified layer 12 is smaller than the adhesion of the surface-modified layer 12 to the flexible metal carrier 10, and the adhesion of the flexible plastic substrate 14 to the flexible metal carrier 10 is greater than the adhesion of the flexible plastic substrate 14 to the surface-modified layer 12. In an embodiment, the adhesion of the flexible plastic substrate 14 to the surface-modified layer 12 is smaller than the adhesion of the surface-modified layer 12 to the flexible metal carrier 10 by 1 B to 5 B, and the adhesion of the flexible plastic substrate 14 to the flexible metal carrier 10 is greater than the adhesion of the flexible plastic substrate 14 to the surface-modified layer 12 by 1 B to 5 B. In an embodiment, the adhesion of the flexible plastic substrate 14 to the flexible metal carrier 10 is 1 B to 5 B, and the adhesion of the flexible plastic substrate 14 to the surface-modified layer 12 is 0 B. Herein, the adhesion is measured by a cross-cut adhesion test method. A material of the flexible plastic substrate 14 may be, for example, polyimide (PI), polycarboxylate (PC), polyether sulfone (PES), PET, PEN, polyamide (PA), pernigraniline (PNB), polyetheretherketone (PEEK) or polyetherimide (PEI) or a combination thereof. A thickness of the flexible plastic substrate 14 is, for example, about 10 μm to 200 μm. The flexible plastic substrate 14 may be formed by various known coating methods, for example, dip coating, spin coating, roll coating or spray coating. Since the material of the carrier 10 is metal, during the coating of the flexible plastic substrate 14, the flexible plastic substrate 14 may not be seriously deformed due to the reel tension of the equipment and the resulting membrane stress, and thus the flexible plastic substrate 14 may be formed by a roll-to-roll method. However, the method of forming the flexible plastic substrate 14 is not limited to the roll-to-roll method, and may also be a sheet-to-sheet method or any other suitable method. The flexible plastic substrate 14 may be formed over the first region 10A and the second region 10B shown in FIG. 2, FIG. 3 or FIG. 4. In the embodiments shown in FIG. 2, FIG. 3 and FIG. 4, the flexible plastic substrate 14 may be formed by, but not limited to, a roll-to-roll continuous coating method, and a sheet-to-sheet coating method may also be used.

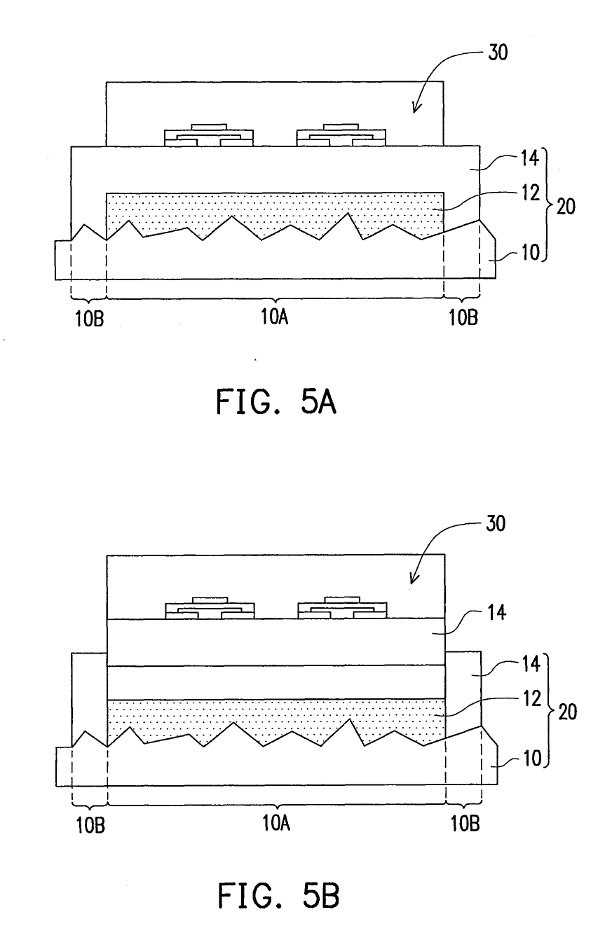

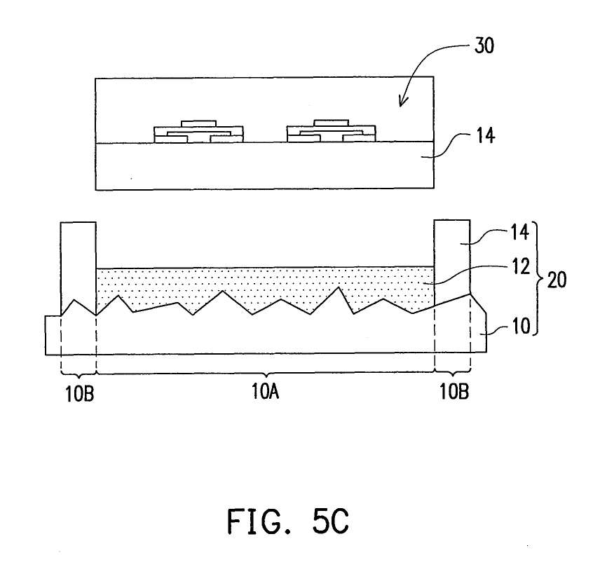

In one embodiment, FIGS. 5A to 5C illustrate a separation mechanism of electronic components using the aforementioned flexible substrate structure.

Referring to FIG. 5A, in practical application, various electronic components 30, for example, a TFT array, a passive component, a sensing component, a touch display, an electrophoretic display or an organic light emitting diode (OLED) display, may be formed over the flexible substrate structure 20.

Referring to FIG. 5B, when the flexible plastic substrate 14 over the first region 10A is cut longitudinally to the surface-modified layer 12, the flexible plastic substrate 14 over the first region 10A is separated from the surface-modified layer 12 thereon, while the flexible plastic substrate 14 over the second region 10B remains on the flexible metal carrier 10. Since the adhesion of the surface-modified layer 12 to the flexible plastic substrate 14 is small, for example, 0 B, a desirable separation interface is formed between the surface-modified layer 12 and the flexible plastic substrate 14. Moreover, since the flexible plastic substrate 14 has a large adhesion to the flexible metal carrier 10 for its high roughness, the flexible plastic substrate 14 may be formed and fixed on the second region 10B of the flexible metal carrier 10. Therefore, when the flexible plastic substrate 14 over the first region 10A is cut longitudinally to the surface-modified layer 12, the flexible plastic substrate 14 over the first region 10A may be automatically separated from the surface-modified layer 12 there-below, while the flexible plastic substrate 14 over the second region 10B remains on the flexible metal carrier 10. The aforementioned cutting method may be diamond knife cutting, laser cutting or mechanical cutting.

Then, referring to FIG. 5C, the flexible plastic substrate 14 that has been separated from the surface-modified layer 12 is removed from the surface-modified layer 12, and the remaining flexible metal carrier 10 may be repeatedly used.

In one embodiment, the flexible substrate structure includes a flexible metal carrier. The rigidity of metal in the flexible metal carrier may overcome the reel tension of the equipment and may reduce the deformation of subsequently formed layer or substrate. As a result, even if the subsequent layer is formed by a roll-to-roll process method, the photolithography thereof still has sufficient alignment precision, so that the lithographic alignment error may be reduced, and the alignment offset may be smaller than 10 μm. Therefore, a patterning process of more than two layers is accomplished, and the yield of the process is increased.

In addition, the flexible substrate structure includes a surface-modified layer. The adhesion of the surface-modified layer to the flexible plastic substrate thereon is smaller than the adhesion of the surface-modified layer to the flexible metal carrier there-below, that is, an excellent separation interface exists between the surface-modified layer and the flexible plastic substrate. Therefore, when the flexible plastic substrate over the first region is cut longitudinally to the surface-modified layer, the flexible plastic substrate over the first region may be automatically separated from the surface-modified layer thereon and be removed.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of fabricating a flexible substrate structure, comprising:
providing a flexible metal carrier comprising at least one first region and at least one second region;
forming a surface-modified layer on the first region of the flexible metal carrier; and
forming a flexible plastic substrate over the first region and the second region of the flexible metal carrier, wherein the flexible plastic substrate over the first region contacts with the surface-modified layer, and the flexible plastic substrate over the second region contacts with the flexible metal carrier.

2. The method of fabricating a flexible substrate structure according to claim 1, wherein an adhesion of the surface-modified layer to the flexible metal carrier is greater than an adhesion of the flexible plastic substrate to the surface-modified layer.

3. The method of fabricating a flexible substrate structure according to claim 1, wherein an adhesion of the flexible plastic substrate to the flexible metal carrier is greater than the adhesion of the flexible plastic substrate to the surface-modified layer.

4. The method of fabricating a flexible substrate structure according to claim 1, wherein the surface-modified layers are formed by a roll-to-roll continuous process.

5. The method of fabricating a flexible substrate structure according to claim 1, wherein the flexible metal carrier comprises a plurality of first regions and a plurality of second regions, the surface-modified layer is formed on each of the first regions of the flexible metal carrier, and the flexible plastic substrate is formed over each of the first regions and each of the second regions of the flexible metal carrier.

6. The method of fabricating a flexible substrate structure according to claim 5, wherein the surface-modified layers are formed by a roll-to-roll discontinuous process.

7. The method of fabricating a flexible substrate structure according to claim 1, further comprising cutting the flexible plastic substrates over the first regions longitudinally to the surface-modified layers, so that the flexible plastic substrates over the first regions are separated from the surface-modified layers below the flexible plastic substrates.
